(19) United States
(12) Patent Application Publication
(10) Pub. No.: US 2011/0116519 A1
(43) Pub. Date: May 19, 2011

(54) APPARATUS AND METHOD FOR CONVERTING LASER ENERGY

(75) Inventors: Lung-Han Peng, Taipei (TW); Chih-Ming Lai, Taipei (TW); I-Ning Hu, Taipei (TW); Ying-Yao Lai, Taipei (TW); Chu-Hsuan Haung, Taipei (TW)

(73) Assignee: NATIONAL TAIWAN UNIVERSITY, Taipei (TW)

(21) Appl. No.: 12/720,162

(22) Filed: Mar. 9, 2010

(30) Foreign Application Priority Data
Nov. 17, 2009 (TW) 98138936

(51) Int. Cl. H01S 3/10

(52) U.S. Cl. 372/21; 372/71

(57) ABSTRACT

Provided are an apparatus and a method for converting laser energy, characterized by employing an optical parametric oscillator for converting light of a green laser wavelength into light of a blue or red laser wavelength via a phase matching structure, by means of a non-linear optical crystal having a one-dimensional quasi-phase matching structure with a single grating period under appropriately-controlled temperature conditions. The non-linear optical crystal with the single grating period facilitates optical parametric oscillation and second harmonic generation to thereby enable green-to-blue wavelength conversion with a slope efficiency greater than 20%. Under 400 mW green light pump laser action, a periodically poled LiTaO₃ crystal with a crystal length of 15 mm and without a resistant reflective plating film on its end face is capable of outputting a blue light laser beam of 56 mW.

### BACKGROUND OF THE INVENTION

1. Field of the Invention

The present invention relates to apparatuses and methods for converting laser energy, and more particularly, to an apparatus and method for converting laser energy so as to simultaneously complete first-stage quasi-phase matching-based infrared optical parametric conversion and second-stage quasi-phase matching-based second-order harmonic conversion by means of a one-dimensional quasi-phase matching device with a single grating period of periodically inverted domain structure.

2. Description of the Prior Art

These days, projection display devices are easy to install and diverse in display capability and therefore are popular with consumers and taken seriously by manufacturers. Existing projection display technology includes liquid crystal-based and plasma-based projection techniques, among others. However, the existing projection display technology is confronted with numerous problems, such as imprecise color, and light dispersion.

To overcome the above drawbacks of the prior art, laser projection display technology has been developed and has become an effective, cost-efficient alternative to liquid crystal-based projection techniques and plasma-based projection techniques. Laser projection display technology provides a green-blue combination framework that is leading the projection display industry into a new era. Advantages of laser projection display technology include: precise color control, concentrated light sources, laser purity which is much higher than that of high-resolution display technology, twice the color space of liquid crystal TV or plasma TV technology, and low power consumption. Moreover, the power consumption of projection systems utilizing laser projection display technology is approximately half that of liquid crystal TVs and one-third that of plasma TVs; hence, laser projection display technology complies with the trend of using green devices. Recently, laser projectors for use in projection displays were launched in the market. The commercially available laser projectors, which demonstrate output (luminosity) of up to 7000 lumens and use three primary colors (RGB) as laser sources, not only have 30% higher illumination efficiency than ordinary projectors equipped with electric light bulbs, but also have a color gamut equivalent to 170% of the NTSC standard and two times the range of color reproduction of liquid crystal TVs.

More importantly, owing to the maturity of projection display technology and ever-increasing demand for smaller projection display devices, development of small projection devices is a major focus of attention. Replacing LEDs with smaller laser sources is not only effective in reducing power consumption and physical size while providing bright color and high contrast, but also conducive to the display of sharp images regardless of the distance of laser projection from the screen or projection surface. Hence, development of miniaturized laser sources can have direct impact on the progress made in the development of projection devices. A current trend of projection technology is to apply laser technology to projection technology or even electronic devices, such as cellular phones. For example, in the case where LEDs function as the light source of a portable projection cellular phone or a portable projector, a projector of 10 lumens can cast light on a maximum area of 50 square inches, but the focal length of the projection must be adjusted according to the projection coverage area. Replacing the LEDs with miniature laser sources is not only effective in reducing power consumption and dimensions and providing bright color and high contrast, but also useful for making long-distance projection and large-area-coverage projection without adjusting the focal length. Therefore, laser-based displays are an inevitable focus of attention in display technology.

However, the existing bottleneck for the development of laser energy conversion technology is due to the low-energy conversion efficiency techniques for producing the three primary colors: red, green, and blue.

In conclusion, laser technology is inevitably involved in the development of display technology and projection technology. Laser energy conversion devices characterized by high optical conversion efficiency and miniature size are expected to be applied to laser projection displays or high-resolution displays. However, existing laser energy conversion technology is not effective in terms of laser energy conversion efficiency and miniaturization and thus is not readily applicable to the manufacture of portable projection devices. Accordingly, it is imperative to provide a laser energy conversion device and method for enhancing ease of manufacturing and energy conversion efficiency.

### SUMMARY OF THE INVENTION

In light of the aforesaid drawbacks of the prior art, it is a primary objective of the present invention to provide an apparatus and method for converting laser energy so as to simultaneously complete first-stage quasi-phase matching-based infrared optical parametric conversion and second-stage quasi-phase matching-based second-order harmonic conversion by means of a one-dimensional quasi-phase matching device with a single grating period of periodically inverted domain structure.

To achieve the above and other objective, the present invention provides an apparatus for converting laser energy, comprising: a non-linear optical crystal comprising a plurality of polar regions, a light incident end, and a light-emitting end, wherein two adjacent polar regions are of opposite polarity so as for a one-dimensional quasi-phase matching structure of a single grating period to be formed from the polar regions, and wherein the grating period is the sum of thickness of the two adjacent polar regions along a common axis thereof; a temperature controller for controlling the temperature of a heater thermally coupled to the non-linear optical crystal for regulating the temperature of the non-linear optical crystal; and a pump laser source aligned with the common axis of the non-linear optical crystal to allow pump laser beams emitted from the pump laser source to enter the light incident end, pass the plurality of polar regions in sequence, and exit the light-emitting end.

The present invention further provides a method for converting laser energy, comprising the steps of: providing a non-linear optical crystal, and forming a one-dimensional quasi-phase matching structure comprising a plurality of polar regions, a light incident end, and a light-emitting end being of a single grating period ranging from 8 μm to 15 μm; providing a temperature controller for controlling the temperature of a heater thermally coupled to the non-linear optical crystal for controllably keeping the temperature of the non-linear optical crystal between 10° C. and 165° C.; and aligning a pump laser source with the common axis of the non-linear optical crystal to allow 480 nm to 575 nm pump laser beams emitted from the pump laser source to enter the light incident end, pass the plurality of polar regions in sequence, and exit the light-emitting end in the form of laser light with a converted wavelength between 590 nm and 650 nm.

The present invention further provides a method for converting laser energy, comprising the steps of: providing a non-linear optical crystal, and forming a one-dimensional quasi-phase matching structure comprising a plurality of polar regions, a light incident end, and a light-emitting end being of a single grating period ranging from 5 μm to 8 μm; providing a temperature controller for controlling the temperature of a heater thermally coupled to the non-linear optical crystal for controllably keeping the temperature of the non-linear optical crystal between 10° C. and 165° C.; and aligning a pump laser source with the common axis of the non-linear optical crystal to allow 480 nm to 575 nm pump laser beams emitted from the pump laser source to enter the light incident end, pass the plurality of polar regions in sequence, and exit the light-emitting end in form of laser light with a converted wavelength between 395 nm to 465 nm.

In another embodiment, the apparatus for converting laser energy according to the present invention further comprises the step of providing a laser resonant cavity between the light incident end and the light-emitting end of the non-linear optical crystal, the laser resonant cavity being defined by an input coupling and an output coupling and being shaped like a biconcave cavity, wherein the input coupling and the output coupling are plano-concave mirrors and each have a concave side facing the non-linear optical crystal.

The present invention provides an apparatus and method for converting laser energy so as to simultaneously complete first-stage quasi-phase matching-based infrared optical parametric conversion and second-stage quasi-phase matching-based second-order harmonic conversion by means of a one-dimensional quasi-phase matching structure with a single grating period, allow a non-linear optical crystal to convert green laser light to red and blue laser light by means of a one-dimensional quasi-phase matching structure with a single grating period, and enable miniaturization of energy conversion devices and enhancement of laser energy conversion efficiency.

### BRIEF DESCRIPTION OF THE DRAWINGS

FIG. 1 is a block diagram of a measurement framework of an apparatus for converting laser energy in an embodiment according to the present invention;

FIG. 2 is a diagram of a quasi-phase matching structure for use with the apparatus for converting laser energy according to the present invention;

FIG. 3 is a graph of the wavelength of the output laser against temperature involving conversion of 532 nm pump laser light into 630 nm red laser light by the apparatus for converting laser energy according to the present invention;

FIG. 4 is a graph pertaining to the efficiency of energy conversion of the 532 nm pump laser light into 630 nm red laser light by the apparatus for converting laser energy according to the present invention; and

FIG. 5 is a graph pertaining to the efficiency of energy conversion of the 532 nm pump laser light into 434.7 nm blue laser light by the apparatus for converting laser energy according to the present invention.

### DETAILED DESCRIPTION OF THE EMBODIMENTS

The present invention is herein illustrated with specific embodiments, so that one skilled in the pertinent art can easily understand other advantages and effects of the present invention from the disclosure of the invention.

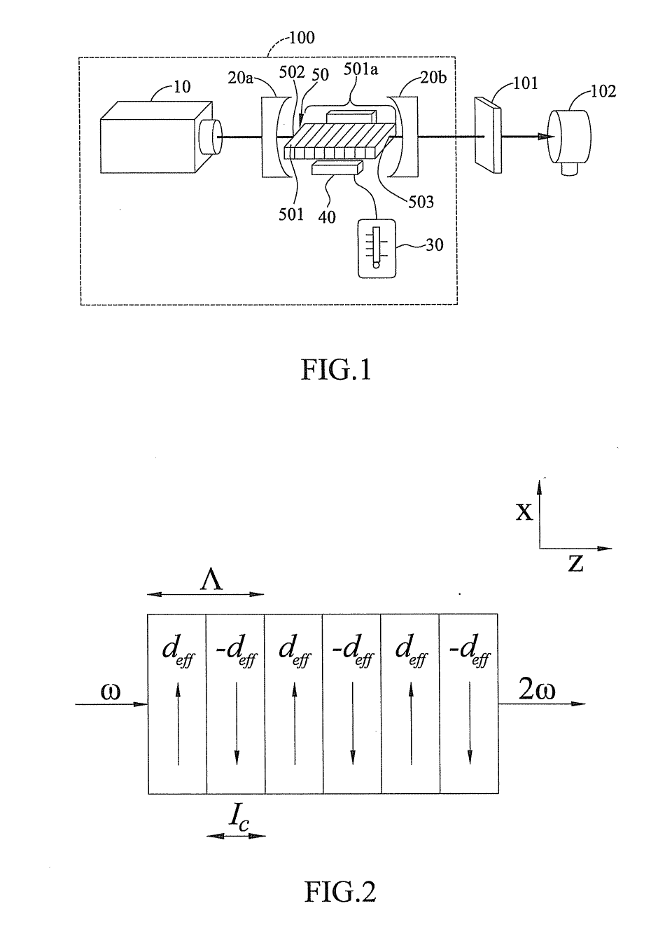

FIG. 1 depicts a block diagram of a measurement framework of an apparatus for converting laser energy in an embodiment according to the present invention. As shown in the drawing, the apparatus for converting laser energy according to the present invention is, for example, an optical parametric oscillator 100. The optical parametric oscillator 100 comprises a green light pump laser source 10 operating at a frequency between 480 nm and 575 nm, an input coupling (IC) 20a, an output coupling (OC) 20b, a temperature controller 30, a heater 40, and a non-linear optical crystal 50. In this embodiment, the measurement framework of the optical parametric oscillator 100 is best illustrated with an optical route diagram of the optical parametric oscillator 100.

Referring to FIG. 1, a Q-switch green laser is adjusted to operate at 20 ns pulse width and 4 KHz repetition rate so as to function as a pump laser source. Upon completion of a fabrication process, the non-linear optical crystal 50 made of periodically-poled lithium tantalate (PPLT) comprises a plurality of polar regions 501, a light incident end 502, and a light-emitting end 503. Each two adjacent polar regions 501 are of opposite polarity so as for a one-dimensional quasi-phase matching structure 501a of a single grating period to be formed from the polar regions 501. The grating period is the sum of the thickness of two adjacent polar regions 501 along their common axis.

The non-linear optical crystal 50 is located inside a resonant cavity. The resonant cavity is a biconcave cavity defined by an input coupling 20a and an output coupling 20b. Both the input coupling 20a and the output coupling 20b are plano-concave mirrors providing high transmission to laser beams with a wavelength between 480 nm to 575 nm, wherein the radii of curvature of the mirrors are between 25 μm and 100 μm. The input coupling 20a and the output coupling 20b each have a concave side that faces the non-linear optical crystal 50. The temperature controller 30 controls the temperature of the heater 40. The heater 40 is thermally coupled to the non-linear optical crystal 50 for regulating the temperature of the non-linear optical crystal 50. The input coupling 20a is highly reflective toward laser beams of wavelengths ranging from 430 nm to 440 nm, from 620 nm to 640 nm, and from 860 nm to 880 nm so as to lock in a beam for generating resonance. The purpose of reflecting the blue laser light ranging from 430 to 440 nm off the input coupling 20a is to allow laser energy to be unilaterally transmitted out and thereby to render the measurement conveniently. Likewise, the output coupling 20b is configured to demonstrate a high degree of reflectivity toward laser beams of wavelengths ranging from 860 nm to 880 nm so as to lock in a beam for generating resonance. However, the output coupling 20b is configured to demonstrate reflectivity, in part, towards a red laser beam of a wavelength ranging from 620 nm to 640 nm such that resonant energy of the locked in red laser light of wavelengths ranging from 620 nm to 640 nm is sufficient to emit red laser light and enable a red laser beam of a desirable wavelength to be extracted by a replaceable filter 101 and measured in conjunction with a power meter 102. A green light pump laser source 10 of a wavelength ranging from 480 nm to 575 nm is aligned with the common axis of the non-linear optical crystal 50 to allow pump laser beams emitted from the pump laser source 10 to pass through the plurality of polar regions 501 in sequence.

The non-linear optical crystal 50 is a one-dimensional quasi-phase matching structure of a single period (Λ) and comprises a periodically-poled ferroelectric domain material. The ferroelectric domain material is lithium niobate, lithium tantalate, magnesium-doped or zinc-doped lithium niobate, or magnesium-doped or zinc-doped lithium tantalite.

The purpose of the resonant cavity defined by the input coupling 20a and the output coupling 20b is to increase the energy of signal beams and thereby provide the preferred conversion efficiency; in other words, it is feasible that the optical parametric oscillator 100 shown in FIG. 1 is selectively not provided with the resonant cavity.

The input coupling 20a of the present invention demonstrates a high degree of reflectivity toward laser light of wavelengths ranging from 395 nm to 465 nm, wavelengths ranging from 590 nm to 650 nm, and wavelengths ranging from 790 nm to 930 nm. The output coupling 20b of the present invention demonstrates a high degree of reflectivity toward laser light of wavelengths ranging from 790 nm to 930 nm and demonstrates a high degree of reflectivity, in part, toward laser light of wavelengths ranging from 590 nm to 650 nm. Hence, the ranges of the wavelengths of the input coupling and output coupling should be regarded as illustrative of the preferred embodiments of the present invention rather than restrictive of the claims of the present invention.

Hence, in other embodiments of the present invention, the optical parametric oscillator 100 shown in FIG. 1 can work without the resonant cavity; in other words, pump laser beams emitted from the green light pump laser source 10 travel along the common axis and eventually pass through the non-linear optical crystal 50 without penetrating the input coupling 20a and the output coupling 20b present in the prior embodiment; hence, pump laser beams emitted from the green light pump laser source 10 enter the light incident end 502, pass through the plurality of polar regions 501, and eventually exit the light-emitting end 503.

Referring to FIG. 2, shown is a schematic view of a quasi-phase matching structure for use with the optical parametric oscillator 100 shown in FIG. 1 according to the present invention. As shown in the drawing, the sign of equivalent non-linear coefficient d_{eff} of the quasi-phase matching structure changes periodically, that is, at the beginning of every other coherence length lc, in the course of propagation of laser beams so as for the quasi-phase matching structure to form a periodic grating structure, wherein the period (Λ) denotes the period of modulation of the non-linear coefficient in space and amounts to the sum of thickness of two adjacent polar regions 501, the two adjacent polar regions 501 having oppositely signed equivalent non-linear coefficients. In this embodiment, the duty-cycle of the grating period of the non-linear optical crystal 50 ranges from 1% to 99% and preferably from 25% to 75%.

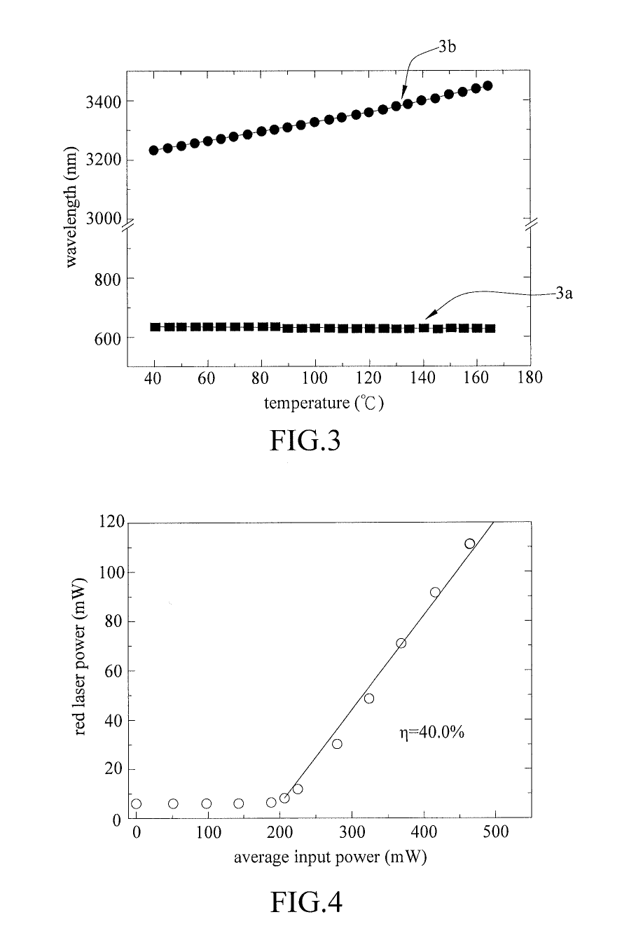

In a preferred embodiment of the present invention, conversion of green laser light with a wavelength of 532 nm into red laser light with a wavelength of 630 nm is implemented by the optical parametric oscillator 100 shown in FIG. 1. This embodiment differs from the preceding embodiments in that, in this embodiment, a green light pump laser source with a wavelength of 532 nm is used, and the optical parametric oscillator 100 comprises the single-period non-linear optical crystal 50 having a period of 11.6 μm, a length of 15 mm, a width of 6 mm, and a thickness of 0.5 mm, not to mention that the temperature controller 30 controls the temperature of the heater 40 so as for the temperature of the non-linear optical crystal 50 to be kept at between 40° C. and 165° C. In this embodiment, laser light generated by oscillation is characterized by: wavelengths ranging from 629 nm to 636 nm, wavelengths ranging from 3229 nm to 3444 nm in the case of idler beams, and exhibits a correlation between the wavelength of the output laser against temperature (see FIG. 3).

Referring to FIG. 3, shown is a graph of the wavelength of the output laser against temperature regarding conversion of a 532 nm pump laser from the optical parametric oscillator 100 into 630 nm red laser according to the present invention. As shown in the drawing, despite a temperature change, the wavelength of the output signal beams (depicted by curve 3a) is always a red laser wavelength with no significant variation thereof. Stability over temperature changes is one of the advantages of an optical parametric oscillation-based red laser generator. By contrast, the median wavelength of the idle beams (depicted by curve 3b) ranges between 3200 nm and 3450 nm.

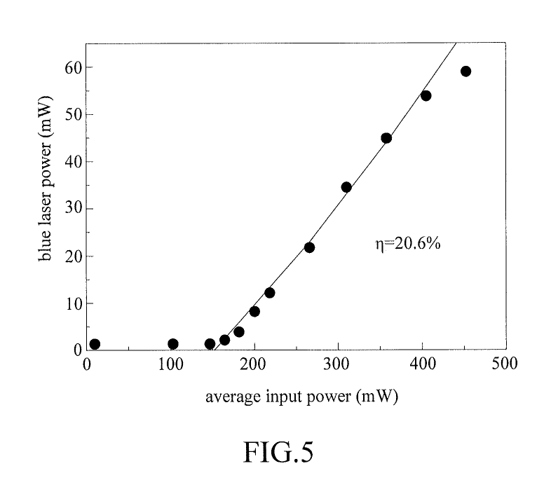

Referring to FIG. 4, shown is a graph pertaining to the efficiency of the energy conversion of a 532 nm pump laser of the optical parametric oscillator 100 into 630 nm red laser according to the present invention. This embodiment differs from the preceding embodiments in that, in this embodiment, the temperature controller 30 controls the temperature of the heater 40 to thereby controllably keep the temperature of the non-linear optical crystal 50 at 153° C. The single-period non-linear optical crystal 50 with a period of 11.6 μm achieves quasi-phase matching at 153° C., and, as a consequence, it is feasible to directly obtain output red laser light with a wavelength of 630 nm and idler infrared light with wavelength of 3420 nm under the optical parametric oscillation principle. It is feasible to achieve linear conversion of green laser light with wavelength of 532 nm into red laser light with a wavelength of 630 nm with a slope conversion efficiency up to 40.0% by controllably keeping the temperature at the optimal quasi-phase matching temperature, that is, 153° C., and changing the power of the pump laser sources.

In yet another preferred embodiment of the present invention, conversion of green laser light with wavelength of 532 nm into blue laser light with a wavelength of 434.7 nm is implemented by the optical parametric oscillator 100 shown in FIG. 1. The resonant cavity jointly defined by the input coupling 20a and the output coupling 20b provides an intra-cavity multi-frequency for generating high-efficiency, multi-frequency blue laser light, and thus is effective in overcoming a drawback of the prior art, that is, the low equivalent non-linear coefficient of high-level quasi-phase matching and thus deteriorated conversion efficiency. The application of laser cavity mirrors and laser plating enables the 870 nm signal beams generated by optical parametric conversion to resonate and propagate to and fro between the two laser cavity mirrors and be fed back into a laser chip for generating 434.7 nm multi-frequency blue laser light. However, the application of the laser cavity mirrors and laser plating does not contribute to any technical solutions disclosed in the present invention and thereby is not described herein.

The distinguishing technical features of this embodiment, which distinguish this embodiment from the preceding embodiments, are as follows: a green light pump laser source with wavelength of 532 nm is used; the single-period non-linear optical crystal 50 of the optical parametric oscillator 100 is of a period ranging from 7.89 μm to 8.0 μm, a length of 10 mm, a width of 6 mm, and a thickness of 0.5 mm; and the temperature controller 30 controls the temperature of the heater 40 to thereby controllably keep the temperature of the non-linear optical crystal 50 between 40° C. and 165° C. In this embodiment, signal beams generated by oscillation are of a wavelength between 868 nm and 870 nm, and the signal beams thus generated resonate and propagate to and fro between two laser cavity mirrors before being fed into a laser chip for generating 434.7 nm multi-frequency blue laser light. Conversion of green laser light with a wavelength of 532 nm into blue laser light with a wavelength of 434.7 nm is illustrated with FIG. 5.

Referring to FIG. 5, shown is a graph pertaining to efficiency of energy conversion of 532 nm pump laser light into 434.7 nm blue laser light in the optical parametric oscillator 100 in an embodiment according to the present invention. Unlike the preceding embodiments, in this embodiment, the temperature of the heater 40 is controlled by the temperature controller 30 to thereby controllably keep the temperature of the non-linear optical crystal 50 at 163.3° C. At a temperature of 163.3° C., the single-period non-linear optical crystal 50 of a period of 7.89 μm achieves quasi-phase matching to thereby directly enable optical signal output of a wavelength of 869.4 nm for being fed into a laser chip for generating 434.7 nm blue laser light according to the optical parametric oscillation principle. It is feasible to achieve linear conversion of green laser light with a wavelength of 532 nm into blue laser light with a wavelength of 434.7 nm with a slope conversion efficiency up to 20.6% by controllably keeping the temperature at the optimal quasi-phase matching temperature, that is, 163.3° C., and changing the power of pump laser sources.

The wavelength of the green light pump laser source 10 of the optical parametric oscillator 100 ranges from 480 nm to 575 nm. The temperature of the non-linear optical crystal 50 ranges from 10° C. to 165° C. The grating period of the non-linear optical crystal 50 ranges from 5 μm to 15 μm. With the optical parametric oscillator 100 of the present invention, green laser light is converted into red laser light with a wavelength ranging from 590 nm to 650 nm or blue laser light with a wavelength ranging from 395 nm to 465 nm. Hence, in the above embodiment, the range of wavelengths of the green light pump laser source 10, the temperature of the non-linear optical crystal, the grating period of the non-linear optical crystal, and the wavelength of red laser light and blue laser light obtained by conversion using the optical parametric oscillator 100 are intended to be illustrative of the preferred embodiments of the present invention rather than restrictive of the claims of the present invention.

In conclusion, the present invention provides an apparatus for converting laser energy. The apparatus has an optical parametric oscillator structure. A non-linear optical crystal with a one-dimensional quasi-phase matching structure has a single grating period. Under appropriately-controlled temperature conditions, green laser light is converted into red laser light or blue laser light. Unlike the prior art, the present invention discloses converting green laser light into red laser light or blue laser light by a non-linear optical crystal of a single grating period and according to the optical parametric oscillation principle, and the present invention provides a downsized apparatus for converting laser energy for use with portable projection devices.

The foregoing descriptions of the detailed embodiments are provided to illustrate and disclose the features and functions of the present invention and are not intended to be restrictive of the scope of the present invention. It should be understood by those in the art that many modifications and variations can be made according to the spirit and principles in the disclosure of the present invention and yet still fall within the scope of the invention as set forth in the appended claims.

What is claimed is:

1. An apparatus for converting laser energy, comprising:
a non-linear optical crystal comprising a plurality of polar regions, a light incident end, and a light-emitting end, wherein each two adjacent polar regions are of opposite polarity so as for a one-dimensional quasi-phase matching structure of a single grating period to be formed from the polar regions, in which the grating period is a sum of a thickness of two adjacent polar regions along a common axis thereof;
a temperature controller for controlling a temperature of a heater thermally coupled to the non-linear optical crystal for regulating a temperature of the non-linear optical crystal; and
a pump laser source aligned with the common axis of the non-linear optical crystal to allow pump laser beams emitted from the pump laser source to enter the light incident end, pass through the plurality of polar regions in sequence, and exit the light-emitting end.

2. The apparatus of claim 1, wherein the grating period, the temperature, the wavelength of the pump laser beams, and the converted wavelength of the laser light range between 8 μm and 15 μm, between 10° C. and 165° C., between 480 nm and 575 nm, and between 590 nm and 650 nm, respectively.

3. The apparatus of claim 1, wherein the grating period, the temperature, the wavelength of the pump laser beams, and the converted wavelength of the laser light range between 5 μm and 8 μm, between 10° C. and 165° C., between 480 nm and 575 nm, and between 395 nm to 465 nm, respectively.

4. The apparatus of claim 1, further comprising a laser resonant cavity provided between the light incident end and the light-emitting end of the non-linear optical crystal that is defined by an input coupling and an output coupling, and shaped like a biconcave cavity, wherein the input coupling and the output coupling are plano-concave mirrors and each have a concave side facing the non-linear optical crystal.

5. The apparatus of claim 4, wherein the input coupling and the output coupling are plano-concave mirrors of high penetratability by laser beams with a wavelength between 480 nm to 575 nm and of radii of curvature between 10 mm and 100 mm, the input coupling being highly reflective toward laser beams of a wavelength ranging from 395 nm to 465 nm, from 590 nm to 650 nm, and from 790 nm to 930 nm, and the output coupling being highly reflective toward laser beams of a wavelength ranging from 790 nm to 930 nm and being partially reflective toward laser beams of a wavelength ranging from 590 nm to 650 nm.

6. The apparatus of claim 1, wherein the non-linear optical crystal comprises a periodically-poled ferroelectric phase material selected from the group consisting of lithium niobate, lithium tantalate, magnesium-doped or zinc-doped lithium niobate, and magnesium-doped or zinc-doped lithium tantalite.

7. The apparatus of claim 1, wherein the duty-cycle of the grating period of the non-linear optical crystal ranges from 1% to 99%.

8. A method for converting laser energy, comprising the steps of:
providing a non-linear optical crystal, forming a one-dimensional quasi-phase matching structure comprising a plurality of polar regions, a light incident end, and a light-emitting end, and being of a single grating period ranging from 8 μm to 15 μm;
providing a temperature controller for controlling the temperature of a heater thermally coupled to the non-linear optical crystal for controllably keeping the temperature of the non-linear optical crystal between 10° C. and 165° C.; and
aligning a pump laser source with the common axis of the non-linear optical crystal to allow 480 nm to 575 nm pump laser beams emitted from the pump laser source to enter the light incident end, pass through the plurality of polar regions in sequence, and exit the light-emitting end in the form of laser light with a converted wavelength between 590 nm and 650 nm.

9. The method of claim 8, further comprising the step of providing a laser resonant cavity between the light incident end and the light-emitting end of the non-linear optical crystal, the laser resonant cavity being defined by an input coupling and an output coupling and shaped like a biconcave cavity, wherein the input coupling and the output coupling are plano-concave lenses and each have a concave side facing the non-linear optical crystal.

10. The method of claim 8, wherein the input coupling and the output coupling are plano-concave mirrors of high penetratability by laser beams with a wavelength between 480 nm to 575 nm and of radii of curvature between 10 mm and 100 mm, the input coupling being highly reflective toward laser beams of a wavelength ranging from 395 nm to 465 nm, from 590 nm to 650 nm, and from 790 nm to 930 nm, and the output coupling being highly reflective toward laser beams of a wavelength ranging from 790 nm to 930 nm and being partially reflective toward laser beams of a wavelength ranging from 590 nm to 650 nm.

11. The method of claim 8, wherein the non-linear optical crystal comprises a periodically-poled ferroelectric phase material selected from the group consisting of lithium niobate, lithium tantalate, magnesium-doped or zinc-doped lithium niobate, and magnesium-doped or zinc-doped lithium tantalite.

12. The method of claim 11, wherein the duty-cycle of the grating period of the non-linear optical crystal ranges from 1% to 99%.

13. A method for converting laser energy, comprising the steps of:
providing a non-linear optical crystal, forming a one-dimensional quasi-phase matching structure comprising a plurality of polar regions, a light incident end, and a light-emitting end and being of a single grating period ranging from 5 μm to 8 μm;
providing a temperature controller for controlling the temperature of a heater thermally coupled to the non-linear optical crystal for controllably keeping the temperature of the non-linear optical crystal between 10° C. and 165° C.; and
aligning a pump laser source with the common axis of the non-linear optical crystal to allow 480 nm to 575 nm pump laser beams emitted from the pump laser source to enter the light incident end, pass the plurality of polar regions in sequence, and exit the light-emitting end in the form of laser light with a converted wavelength between 395 nm to 465 nm.

14. The method of claim 13, further comprising the step of providing a laser resonant cavity between the light incident end and the light-emitting end of the non-linear optical crystal, the laser resonant cavity being defined by an input coupling and an output coupling and shaped like a biconcave cavity, wherein the input coupling and the output coupling are plano-concave mirrors and each have a concave side facing the non-linear optical crystal.

15. The method of claim 13, wherein the input coupling and the output coupling are plano-concave lenses of high penetratability by laser beams with a wavelength between 480 nm to 575 nm and are of radii of curvature between 10 mm and 100 mm, the input coupling being highly reflective toward laser beams of a wavelength ranging from 395 nm to 465 nm, from 590 nm to 650 nm, and from 790 nm to 930 nm, and the output coupling being highly reflective toward laser beams of a wavelength ranging from 790 nm to 930 nm and being partially reflective toward laser beams of a wavelength ranging from 590 nm to 650 nm.

16. The method of claim 13, wherein the non-linear optical crystal comprises a periodically-poled ferroelectric phase material selected from the group consisting of lithium niobate, lithium tantalate, magnesium-doped or zinc-doped lithium niobate, and magnesium-doped or zinc-doped lithium tantalite.

17. The method of claim 16, wherein the duty-cycle of the grating period of the non-linear optical crystal ranges from 1% to 99%.
